(19) United States
(12) Patent Application Publication
(10) Pub. No.: US 2017/0069029 A1
(43) Pub. Date: Mar. 9, 2017

(54) Leveraging to Minimize the Expected Inverse Assets

(71) Applicant: Rory Mulvaney, Fargo, ND (US)

(72) Inventor: Rory Mulvaney, Fargo, ND (US)

(21) Appl. No.: 14/848,451

(22) Filed: Sep. 9, 2015

Related U.S. Application Data
(63) Continuation-in-part of application No. 14/480,587, filed on Sep. 8, 2014, now abandoned.

(51) Int. Cl. G06Q 40/06

(52) U.S. Cl. CPC G06Q 40/06

(57) ABSTRACT

The question of how much should be placed at risk on a given investment, relative to the total assets available for investment, is basically that of determining the optimal leverage. The approach taken by the method described in this specification is to optimize the expected future inverse assets, conditioned on having some forecast distribution of the future return on assets. The expected inverse assets is shown to outperform the Kelly Criterion, an existing well known method for calculating optimal leverage, using a simple cross evaluation method, whereby the optimum leverage according to one method is measured using the other method's utility function. The expected inverse assets measure outperforms the Kelly Criterion in the two analytic scenarios considered, a Gaussian distribution of log-returns and a Bernoulli distribution of linear returns. Example usage of the expected inverse asset utility or objective function is provided by the specification of a system of processing histograms that represent the forecast return distributions of investments. It is also shown how this system can be applied specifically to leveraging with market equities, leveraging with debt, leveraging in insurance, and leveraging in a retirement portfolio.

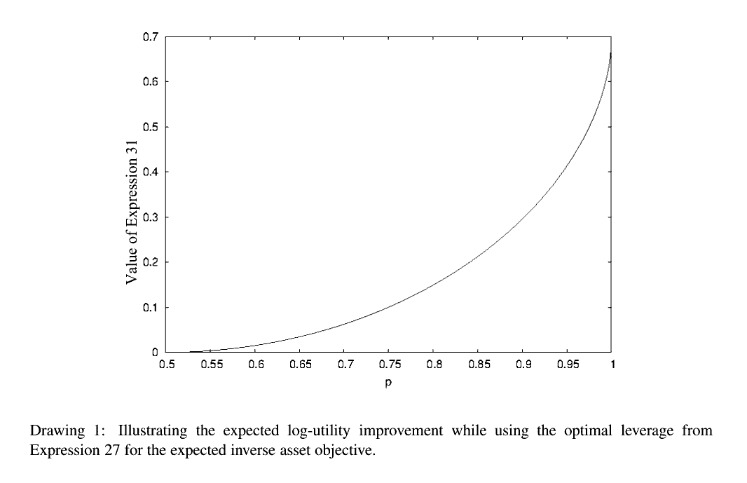

### 1 TECHNICAL FIELD

A very important high-level strategy in finance relates to the amount of money to place at risk, or equivalently, how much leverage to apply. This is a field relating to Finance and Actuary Science. Because financial time series are often analyzed using probability distribution, this is also a field related to Probability Theory. Finally, numerical computing techniques from Computer Science are also involved. The invention claims seem to fit most appropriately into the U.S. patent classification 705/36R, on portfolio selection, planning, or analysis.

### 2 BACKGROUND

Leverage can be thought of as a multiplier of the assets eligible for investment, controlling the fraction of one's money that is invested or being bet on something. It is of course possible to actually invest multiples of one's assets through borrowing money “on margin” to invest it. The leverage is a fraction, where the numerator is the portion of assets actually placed at risk as investment, and the denominator is the total portion of the gross assets that are being considered eligible for investment, possibly including debt assets but excluding margin account debt. The reason margin debt is not considered in the denominator is that it is itself dependent on the numerator and denominator as defined above, and so it would create a sort of double-dependence complexity if it were considered part of the denominator.

A leverage-dependent criterion (from which the optimal leverage is derived) can be derived from the projected distribution of investment returns using a utility function. Thus there are two important variables in the process: (a) perhaps most importantly, the choice of the utility function, and (b) the choice of the model for the future distribution of returns.

Perhaps the most basic method to predict the future distribution of the logarithm of a stock price is to model it using Brownian motion with drift, also known as a Wiener process with drift, having a time-dependent Gaussian distribution “with drift” that may be expressed as

$${p}_{Gauss} ( x ; ln ( {A}_{0} ) + uT , {σ}^{2} T ) , where \\ {p}_{Gauss} ( x ; m , {s}^{2} ) = \frac{1}{\sqrt{2 π s}} {e}^{\frac{- {( x - m )}^{2}}{2 {s}^{2}}} . \qquad ( 1 )$$

Note that p(x; m, s²) is simply a Gaussian distribution in x with mean m and variance s². In this formula, u is the growth rate per unit time T in the log-value log(A) (where A₀ represents the starting value of the stock or assets), and σ² represents the variance of the growth in log-assets per time period.

In this specification the term “volatility” refers to σ (the standard deviation of the growth in log-assets per time period), though sometimes other literature defines volatility differently. Also note that in this specification, the term “log-return” is the return in logarithm space, which refers to the logarithm of one plus the linear return fraction (or alternatively, relative linear return, or simply linear return), so that in Expression 1 above, μ is the mean log-return after time T. Observe that μ is also the log-return rate of the logarithm of one plus the linear return fraction

$$\frac{{A}_{0} ( {e}^{uT} - 1 )}{{A}_{0}} .$$

$$log \text{-} return = log ( 1 + \frac{Δ x}{x} ) , linear \text{-} return = \frac{Δ x}{x} \qquad ( 2 )$$

Another simple model that may be considered is the binomial distribution for the purpose of modeling a series of win-or-lose bets. Here, the model operates in discrete time steps, whereas the lognormal stock price model above operates in continuous time.

Utility functions are a matter of importance because money is not valued on a linear scale, as illustrated by the St. Petersburg paradox [1, 2]. Bernoulli's 1738 proposed solution to this paradox was that money is probably typically measured on a logarithmic scale.

Literature from several sources on optimizing leverage point to something called the Kelly Criterion [3, 4, 5, 6]. The Kelly Criterion [3] uses a logarithmic utility function in discrete time to basically show the optimal fraction of money to bet, given the true probabilities. In the simplest case of a bet on an event with two possible outcomes, the Kelly Criterion says to bet the fraction 2(p−0.5), where p is the probability of winning with the more probable guess.

According to Chan [4], the Kelly Criterion, which strictly technically speaking, only applies to discrete probability distributions encountered in making discrete-time bets, can also be applied to continuous-time financial time series following a derivation from [5], which derives a leverage-dependent criterion in terms of \hat{μ} and \hat{σ} using a utility function that measures the expected logarithm of the assets. The quantity \hat{μ} is the expected value of the simple uncompounded linear fractional return for a given time period, and \hat{σ} is the standard deviation of a simple win-or-lose distribution of \hat{μ}. In the limit of an infinite number of trials, this derivation by Thorp [5] is summarized by Chan [4] to give the simple formula for the optimal leverage in Expression 3.

$$l = \frac{\hat{μ}}{{\hat{σ}}^{2}} \qquad ( 3 )$$

Chan [4] points out that the Kelly Criterion can be used to further optimize the leverage of an asset that was chosen for its optimal Sharpe ratio, because the Sharpe ratio is basically unaffected by leverage.

According to Chan [4], many stock traders set their leverage according to the “Half Kelly” Criterion, which arbitrarily uses half of the Kelly Criterion leverage from Expression 3.

A patent by Scott, et al. [7] presents the utility function in Expression 4 in terms of the expected wealth E(W), the estimated variance of the wealth Var(W), and the subjective risk tolerance variable τ.

$$U = E ( W ) - \frac{Var ( W )}{τ} \qquad ( 4 )$$

In a paper by Peters [8] the Kelly Criterion for continuous time is again derived (this time to a slightly different result) from a logarithmic utility function, except via a different method utilizing Itô's Lemma and the geometric Brownian motion model of equity prices with the leveraged stochastic differential equation (ignoring riskless returns) from Expression 5.

$$\frac{d x}{x} = μ l d t + σ l d z \qquad ( 5 )$$

Peters applies Itô's lemma to show that log(x) follows a Wiener process with drift given by Expression 6,

$$d ( log ( x ) ) = ( μ l - \frac{{σ}^{2} {l}^{2}}{2} ) d t + σ l d z \qquad ( 6 )$$

thus implying that the distribution of the logarithm of the equity price is Gaussian and changes with time, such that the expected value is

$$log ( {x}_{0} ) + T ( μ l - \frac{{σ}^{2} {l}^{2}}{2} ) ,$$

with variance σ²l²T, where x₀ is the starting equity price. Thus after application of calculus-based symbolic optimization with respect to l, Peters shows that to maximize the expected rate of change of the expected value of the log-assets, the leverage is optimized with:

$${l}_{opt} = \frac{μ}{{σ}^{2}} . \qquad ( 7 )$$

Expression 7 is the same formula as the Kelly Criterion above from Expression 3 except that Peters' derivation defines the variables μ and σ differently (vs. \hat{μ} and \hat{σ}) and from an arguably more realistic price movement model.

Note that because log(x) is a Wiener process with drift, the distributional standard deviation and mean may be found from a time series, allowing for solution for the unknown variables σ and μ, given T and l.

### 3 SUMMARY

### 3.1 Technical Problem: There Exist A Pair of Simple Objective Functions with Valid Optimal Leverage Criteria

As mentioned in the background section, there are two important variables in the process of deriving a leveraging criterion, one of which is the choice of the model for the future distribution of returns. Although we already know the basic probability model for Brownian motion with drift from Expression 1, it does not contain any leverage dependence. To maintain constant leverage (if the leverage is anything other than 1), transactions need to be continually made while the stock price changes. If at first one accidentally ignores Itô's Lemma, and observes that for very small time T,

log(1+lTμ)≈lTμ, (8)

so that the mean log growth rate u and its standard deviation a are seemingly proportional to l for the very small price changes and time increments while the leverage is kept constant. This proportionality of l with the log-return μ and standard deviation a thereof would seemingly lead to the presumption that the distribution of log returns is a Gaussian distribution of the form p_{Gauss}(x; ln(A₀)+lTμ, l²σ²T)

### 3.1.1 Problem: Ignoring Itô's Lemma, Linear Utility Implies Infinite Leverage

The expected linear utility of a leveraged model of Brownian motion with drift is given by Expression 9, where p_{Gauss}(x; m, σ²) is the Gaussian probability density function in x with mean m and variance σ² from Expression 1. Expression 9 computes the expected value of e^{x}, where x represents the log-assets, having a Gaussian distribution specified by Brownian motion with drift, at time T and initial assets A₀. Thus the expected value of e^{x} is the expected value of the assets.

∫_{-∞}^{∞}e^{x}p_{Gauss}(x; log(A₀)+lμ(l)T, σ(l)²l²T)dx (9)

Evaluation of the integral in Expression 9 yields Expression 10.

$$exp ( \frac{T ( 2 lu ( l ) + {l}^{2} {σ ( l )}^{2} + 2 log ( {A}_{0} )}{2} ) \qquad ( 10 )$$

Therefore, maximization, with respect to leverage, of expected assets at time T, implies infinite leverage. Obviously, infinite leverage would result in bankruptcy on the slightest downturn of the stock price, but apparently the rare case of avoiding bankruptcy has such large rewards that it more than compensates for the low value of the bankrupt cases. Apparently, while accidentally ignoring any special effects from Itô's Lemma, linear utility sacrifices too much in safety for the hope of a very lucky win.

### 3.1.2 Problem: Ignoring Itô's Lemma, Logarithmic Utility Implies Infinite Leverage

Evaluation of the logarithmic utility is achieved by replacing e^{x} with x in the integral in Expression 9, to compute the expected log-assets at time T (because the Gaussian distribution is expressed in terms of the logarithm of the assets). The result is given by Expression 11, which again implies infinite leverage upon maximization with respect to leverage.

Tlμ(l)+log(A₀) (11)

To conclude, while accidentally ignoring Itôo's Lemma, it appears that the Kelly Criterion still has some claim to optimality for discrete-time bets, but not for (approximately) continuous-time risk, as that seen in the stock market.

### 3.1.3 Ignorance of Itô's Lemma, and Solution to the Infinite Leverage Problem¹

¹This solution was originally presented in [9].

Upon the above accidental presentation of the infinite leverage problem with both linear and logarithmic utility, the hypothesis may readily be made that perhaps it works to instead minimize the multiplicative inverse of the assets [9, sec. 9]. More generally, one might propose a utility function with the goal of minimizing the expected value of y^{-b}, where y represents the random variable for the assets, and b is a positive real number. The expected value of this generalized utility function may be measured conditionally on a distribution given by the drifting Brownian motion model of the logarithm of assets, by replacing e^{x} in Expression 9 with e^{-bx}, because e^{-bx}=exp(−blog(y))=y^{-b}. Evaluation of that integral leads to Expression 12.

$$exp ( - \frac{T ( 2 blu ( l ) + {b}^{2} {l}^{2} {σ ( l )}^{2} + 2 b log ( {A}_{0} )}{2} ) \qquad ( 12 )$$

Minimization of Expression 12 leads to maximization, at any given T, of the simpler criterion

log(A₀)+(lμ(l)−1/2bl²σ(l)²)T. (13)

Dropping the asset term (because it is not dependent on leverage) and dividing by T, it becomes the maximization of

$$lu ( l ) - \frac{{bl}^{2} {σ ( l )}^{2}}{2} . \qquad ( 14 )$$

This is very similar to the criterion offered by Scott, et al. [7], listed above in Expression 4, except for the important difference that Expression 14 uses its mean and variance variables computed using the logarithm of asset levels, rather than the linear asset levels used by Scott, et al. (in [7], the wealth was multiplied by the return rate plus 1 in EQ#1 of that reference, so the wealth was being measured on a linear scale). Most notably, [7] subtracted the scaled variance from the linear assets, rather than subtracting it from the logarithmic assets, making Expressions 14 and 4 very different from one another.

Differentiating Expression 14 with respect to 1, and assuming lμ(l)=lμ, and lσ(l)=lσ, (i.e., if l is in the region where the leveraged growth rate grows linearly with leverage), and solving for 1, leads to the optimal leverage where the criterion is maximized:

$$optimal leverage , {l}_{opt} = \frac{u}{b {σ}^{2}} . \qquad ( 15 )$$

To fully specify the utility function and optimal leverage, it seems most reasonable to set b=1 in the three previous expressions, making the objective to minimize the expected multiplicative inverse of the assets. (It should be noted that, despite the similarity between Expression 15 using b=1, and Expression 3, the parameters used presumably have quite different definitions.) The primary motivation for this choice of b is that, intuitively, the risk of bankruptcy seems inversely proportional to the amount of assets, and thus this objective would effectively seek to directly minimize the risk of bankruptcy. The term “bankruptcy”, simplified here from its normal definition, is used in the sense that A₀, the total portion of gross assets considered eligible for investment (also used as the denominator component of the leverage) reaches zero.

This utility function differs from the linear and logarithmic utility functions in that the perceived value improves more slowly when the assets are large, as can be seen by observing that the derivatives of the linear, logarithmic, and multiplicative inverse utility functions are proportional to 1, 1 /y, and 1/y², respectively. With the expected multiplicative inverse utility function, it takes a 50% chance of a 100% gain to offset a 50% chance of a 33% loss, because 1/2*1/2+1/2*1/(2/3)=1, yielding no change in the expected reciprocal assets.

### 3.1.4 Acceptance of Itô's Lemma, and the Validity of the Expected Inverse Asset Objective Function

Observe that if the leverage is held constant at 1 (the number one), the above Taylor series analysis from Expression 8 ignored the presence of a distribution around μ. Due to Itô's Lemma (see [10] for a nice derivation of Itô's Lemma), the expected rate of leveraged change of ln(A₀) per unit time is:

lμ−l²σ²/2. (16)

To attempt to re-derive this consequence of Itô's Lemma, start from the stochastic differential equation for geometric Brownian motion in Expression 5. Now adding one to both sides and taking the logarithm of both sides of the equation, it becomes

$$ln ( 1 + \frac{d x}{x} ) = ln ( 1 + l μ d t + l σ d z ) . \qquad ( 17 )$$

The argument of the logarithm is now one plus the linear return. According to the right hand side of Expression 5, dx/x is essentially an infinitesimal Gaussian distributed random variable, and it seems best to first attempt a classical change of variable to find the distribution of the logarithm above. However, because the logarithm is undefined for negative values, and a Gaussian random variable has a two-sided infinite tail, it seems at first that the transform would be undefined for some values of the Gaussian distribution. However, because the Gaussian variable is infinitesimal and therefore somewhat bounded, the transform can still be applied via a different method, using Taylor series. Substituting lμ dt=α and lσ dz=x, and expanding the result in a Taylor series around x=0 using a computer algebra system (CAS), the result is:

$$ln ( 1 + a + x ) \approx ln ( 1 + a ) + \frac{x}{a + 1} - \frac{{x}^{2}}{2 {a}^{2} + 4 a + 2} + \frac{{x}^{3}}{3 {a}^{3} + 9 {a}^{2} + 9 a + 3} - \frac{{x}^{4}}{4 {a}^{4} + 16 {a}^{3} + 24 {a}^{2} + 16 a + 4} . \qquad ( 18 )$$

To help analyze the dz factors present within the powers of x in Expression 18, some insight about the time dependence in z is required. The expected variance of a Wiener process from one time to another is directly proportional to the difference in time, which basically stems from the fact that sums of independent Gaussian-distributed random variables result in a Gaussian random variable with the sum of the variances of its constituent summands. Thus, dz² may be viewed as equivalent to ε²dt, where ε is a sample from a standard normal distribution. Therefore, the x³ and higher order terms may be neglected in Expression 18, as they are proportional to dt^{1.5} and terms in higher order of dt. These terms zero out because they are infinitesimals raised to a power greater than one. Furthermore, although e²dt is another stochastic, it can actually be simply treated as equivalent to its expected value by examining the Taylor series of its moment generating function E[e^{s ε}^{²}^{dt}]. The second and higher moments of the stochastic are nonexistent since they are again directly proportional to higher powers of dt.

The denominators of the terms containing dependence on α are simply dominated by the constant terms, because the terms dependent on a are directly proportional to powers of the infinitesimal dt. Thus, given the definitions of α and x above, Expression 18 further simplifies to:

$$ln ( 1 + a + x ) = ln ( 1 + a ) + l σ d z - \frac{{l}^{2} {σ}^{2} d t}{2} . \qquad ( 19 )$$

Upon further Taylor expansion of log(1+α) around α=0 (because α is proportional to an infinitesimal) and application of similar logic as above, Expression 19 is finally simplified to the familiar-looking consequence of Itô's Lemma:

$$ln ( 1 + a + x ) = l μ d t - \frac{{l}^{2} {σ}^{2} d t}{2} + l σ d z . \qquad ( 20 )$$

Therefore, the logarithm y of one added to the linear fractional gain (1+dx/x) is a Wiener process with drift, and is therefore Gaussian distributed with mean

$$T ( μ l - \frac{{σ}^{2} {l}^{2}}{2} )$$

and variance Tσ²l². Expressed in terms of the initial assets A₀, the distribution is

$${p}_{Gauss} ( y ; ln ( {A}_{0} ) + T ( μ l - \frac{{l}^{2} {σ}^{2}}{2} ) , {Tl}^{2} {σ}^{2} ) . \qquad ( 21 )$$

Having validated Itô's Lemma, and having once suggested that the expected inverse assets are a good measure of value, one should attempt to apply the expected inverse asset measure using the leveraged Gaussian distribution implied by Itô's Lemma.

Computation of the expected inverse assets using the leveraged Gaussian log-return distribution is accomplished using the integral:

∫_{-∞}^{∞}e^{-y}p_{Gauss}(y; ln(A₀)+lTμ−l²Tσ²/2,l²Tσ²)dy (22)

yielding the simpler result

exp(−[ln(A₀)+T(lμ−l²σ²)]). (23)

Now minimization of the expected inverse assets implies maximization of

ln(A₀)+T(lμ−l²σ²). (24)

There is again a marked similarity between this Expression and the above Expression 4 by Scott, et al. The major difference, however, is the highly variable subjective and unjustified τ parameter within Expression 4. Upon calculus-based analytic minimization with respect to the leverage l in Expression 24, we arrive at the optimal leverage for minimization of expected inverse assets,

$${l}_{opt} = \frac{μ}{2 {σ}^{2}} . \qquad ( 25 )$$

Notice that this is the “Half-Kelly” Criterion, mentioned above in the background section. Now instead of being an arbitrary fraction of the Kelly Criterion, use of this criterion is well-justified by a fundamental theoretical result.

By comparison, the expected linear assets integrate to A₀e^{lμT}, implying infinite leverage and ruling it out as a valid objective function; the expected log assets yield the continuous-time Kelly Criterion from Expression 3, with σ′=σ, as anticipated.

Seeing that the expected inverse assets appears to be a valid objective function as far as the Gaussian distribution of log-returns is concerned, it now makes sense to test out the objective function with simple 2-sided bets.

For one trial in a simple 2-sided bet, with inverse assets, the expected utility, with probability of winning as p and betting fraction l, is

$$\frac{p}{1 + l} + \frac{1 - p}{1 - l} \qquad ( 26 )$$

Setting the differential with respect to l to zero and solving for l yields the allowable solution for minimization of expected inverse assets:

$${l}_{opt} = \frac{1 - 2 \sqrt{p - {p}^{2}}}{2 p - 1} . \qquad ( 27 )$$

For two trials of a two-sided bet, the inverse asset objective multiplies the binomial probabilities by the inverse asset outcomes of each possibility.

$$\frac{{p}^{2}}{{( 1 + l )}^{2}} + \frac{{( 1 - p )}^{2}}{{( 1 - l )}^{2}} + 2 \frac{p ( 1 - p )}{( 1 + l ) ( 1 - l )} \qquad ( 28 )$$

Setting the differential with respect to l to zero and solving for l yields the same allowable solution as in Expression 27. In fact, carrying out this analysis on cases 1 trial through 4 trials all yield the same optimal leverage formula for simple 2-sided bets, Expression 27, leading to the conjecture that it is valid as an optimum for any number of bets to be placed.

More generally, for leveraged winning payoff la and leveraged losing cost lc, the optimal leverage analogous to Expression 27 becomes (again conjectured to hold for any number of Bernoulli trials):

$${l}_{opt} = \frac{ac - ( c + a ) \sqrt{ac ( p - {p}^{2} )}}{p ( {ac}^{2} + {a}^{2} c ) - {a}^{2} c} . \qquad ( 29 )$$

To get the idea of how the discrete time leverage criterion in Expression 27 compares to the Kelly Criterion, consider the case when p=0.55. Expression 27 yields a betting fraction of approximately 5.01%, whereas the Kelly Criterion says to bet exactly 10%. Both criteria gradually increase the fraction to 100% as p approaches 1.

Seeing that the inverse asset objective yields valid optima for these simple typical forecasts of returns, there is now the problem and question of whether it is better to maximize the expected logarithmic utility function, or minimize the expected inverse asset objective function.

### 3.2 Solution to Problem: Narrowing Possible Objective Functions to only the Minimization of Expected Inverse Assets

Given these two objective functions with valid optima, they should be somehow compared, to determine whether there is a single prominent measure of value. This can be done using a simple cross evaluation method.

Start by measuring the maximal expected logarithm utility function's optimal leverage using the expected inverse asset objective function, as follows. Plugging the Kelly Criterion leverage from Expression 3, with σ′=σ, into the Expression 24 to be maximized for minimal expected inverse assets simply yields ln(A₀), or zero expected improvement over time.

For the other half of the cross evaluation, the minimal expected inverse assets objective function's optimal leverage is measured using the expected logarithm of assets utility function. Plugging the optimal expected inverse assets' leverage from Expression 25 into the expected rate of leveraged change of ln(A₀) due to Itô's Lemma, lμ−l²σ²/2, yields

$$\frac{3 {μ}^{2}}{8 {σ}^{2}} ,$$

a significant improvement over time.

Though the above analysis applies only to a Gaussian forecast distribution of log-returns, the same method can be applied to the discrete Bernoulli distribution of returns, showing similar results. First, plug the optimal Kelly leverage 2 (p−0.5) into the corresponding inverse asset objective, Expression 26. This simply yields

$$\frac{p}{1 + 2 ⋆ ( p - .5 )} + \frac{1 - p}{1 - 2 ⋆ ( p - .5 )} = \frac{p}{2 p} + \frac{1 - p}{2 - 2 p} = 1 ,$$

or no improvement in the expected inverse assets over time, for any value of p.

Conversely, plugging the expected-inverse-asset-optimal leverage from Expression 27 into the following expected log-asset utility function

plog(1+l)+(1−p)log(1−l) (30)

produces the function

$$p log ( 1 + \frac{1 - 2 \sqrt{p - {p}^{2}}}{2 p - 1} ) + ( 1 - p ) log ( 1 - \frac{1 - 2 \sqrt{p - {p}^{2}}}{2 p - 1} ) . \qquad ( 31 )$$

Expression 31 is plotted in Drawing 1 for winning probability values p on the open domain (0.5, 1). It shows a steadily rising function starting near and above zero, implying that for values of p with winning probability greater than 0.5, there is improvement, over time, in the log-assets.

The above fair comparison using a simple cross evaluation method shows that the expected inverse assets measure is probably a better measure of value or risk, for use in investment decision making, than the expected log assets measure.

### 3.2.1 Optimal Leveraging Should be Determined by the Short Term Return Distribution

Over the long term, log-return distributions are theorized by the geometric Brownian motion model to become Gaussian, due to the continual time convolution of the immediate distribution of log-returns. It is then tempting to find the expected value of the inverse assets given this distribution of returns, to find the optimal leverage. However, if there is another accurate shorter term forecast always available, there may be a more optimal short term strategy, and if method A is always expected to improve the expected inverse assets better than any other method from one moment to the next (given the immediate-term forecast), then unless the present price movement is somehow related to future price movements beyond the foresight of the short-term forecast, no method B could ever recover the ground it has lost to method A. Thus it seems that the optimal timeframe of the short term forecast is approximately either (1) the amount of time required to releverage the portfolio, or (2) the amount of time required for the releveraging benefit to generate acceptable profits despite transaction costs, whichever is greater.

One possible reason the future price movements could be tied to past movements in an unforeseen way is autocorrelation being present in the trading “equity curve” of the investor. If an unexpected level of autocorrelation is present, it means there was something wrong with the immediate-term forecast, which could be dealt with by either directly accounting for the short term equity curve autocorrelation forecast, or probably better yet, finding a correction to the underlying forecast model that accounts for the autocorrelation.

### 3.2.2 Forming a Histogram Distribution from a Historical Time Series

It seems most computationally practical to process general probability distributions as histograms with many intervals. To produce a histogram of “immediate timeframe” forecast log-returns, for example, first a time series of historical log-returns (that somehow also correctly takes account of dividends, capital gains distributions, splits, and reverse splits) could be processed by giving weight (probability) to each sample, sorting the returns by the size of the log-return (computed for example over daily time frames, as log[price(dayᵢ)/price(dayᵢ₋₁)], where dayᵢ is more recent than dayᵢ₋₁), and partitioning the domain of log-returns into intervals by placing partition points between the sorted, weighted samples, giving interval space proportional to the amount of weight of the sample. For example, if two neighboring samples are of equal weight, the partition point would be placed halfway between the two samples. If the left sample has double the weight of the right sample, then the partition point would be placed two-thirds of the way to the right sample, making the left sample's portion of the interval twice as large as the right sample's portion of the interval between the two samples. The left and right ending intervals may be dealt with as the implementor sees fit. Each partition in the domain is then given the weight (probability) of its sample, to produce a histogram representing the probability distribution of log-returns.

Although this structure is a histogram in the sense that it has discrete intervals, it is not exactly a histogram in the sense that there is exactly one sample per interval. The most precise way to refer to this structure is perhaps as a “histogram-multinomial,” because it is a multinomial distribution with the modification that it has histogram-like discrete intervals covering the domain of the function. For simplicity however, this article it will refer to it as a histogram.

The weights given to samples may be exponentially fading according to the expression e^{λt}, with the smaller weights given to older samples. The λ parameter could be optimized to maximize the entropy of the histogram, with the histograms temporarily normalized to unit variance for fairness of the entropy computation.

Further fairly obvious processing would be required to transform that histogram into a histogram having equal-sized intervals, which might be convenient to have for application of nonlinear transforms or evaluation of an expected value. A nonlinear transform is thus performed by first transforming the histogram into an equal-interval histogram, and then applying the nonlinear transform of interest to the interval borders. If the nonlinear transform reverses the ordering from increasing borders to decreasing borders, the ordering of the borders, weights, widths, and heights should be reversed. The weights of each interval remain the same; and the widths and heights of each interval are optionally updated such that the width is the difference in value between the borders of the interval, and the height equals the weight divided by the height, so as to maintain the normalization that the sum of the width-height products equals 1.

The log-return domain is of interest because it should produce more naturally precise forecast histograms for individual investments. As a case in point, two instances of a given log-return μ₁ would place the logarithmic assets twice as far from zero as a single instance of μ₁. The linear return domain is of interest for other operations such as releveraging. The transform from log-returns to linear returns is accomplished with simple application of the nonlinear transform y=e^{x}−1. The reverse nonlinear transform, to obtain the log-return distribution from the linear return distribution, is accomplished with y=log(1+x).

Finally, to produce a true forecast of the return distribution backed by financial analysis, an entire histogram or time series of log-returns could be shifted up or down by an amount to make the mean of the log-return distribution equal to the expected log-return as produced by a true financial analysis, possibly from a financial analyst, of the underlying equity. Then the standard deviation of the log-return distribution could also be adjusted to match the financial analysis-backed estimate of the standard deviation, by simply multiplying or dividing the displacement from the mean of the entire log-return time series or histogram borders by a deviation-matching factor. Other forecast moments or conditions could be similarly expressed by adjustments to this time series or histogram forecast of log-returns.

### 3.2.3 The Distribution of Returns of a Combination of Leveraged Investments, and Optimization Thereof

To express the distribution of returns of a releveraged investment, the histogram must first be in the linear return domain. Then a linear transform y=xl_{new}/l_{old} is applied to the borders x, and the widths and heights are optionally readjusted. Equal width intervals are not required, due to the linearity of the releveraging transform.

Because growth rates add in linear space rather than log-space, a simple convolution of the log-return distributions does not suffice. For example, if the log return distributions being combined actually are Gaussian, with lognormal distributions of linear returns, the combined distribution of returns is a convolution of lognormal distributions, for which it is well known that there is no simple exact mathematical expression (without using integrals) to compute even the resulting mean or standard deviation.

The convolved linear return distribution p_{y}(y) of a combination of linear return random variables x₁, . . . , xₙ, is expressed as

p_{y}(x)=pₓ_{₁}(x)*pₓ_{₂}(x)* . . . * pₓ_{ₙ}(x), (32)

where the asterisk is used to denote the convolution operation, defined as p_{z}(x)=pₓ(x)*p_{y}(x)=∫ pₓ(x−y) p_{y}(y) dy=∫ pₓ(x) p_{y}(y−x) dx (with two forms to illustrate commutativity). In practice, the linear return distributions could be expressed as histograms, and the discrete summation form of the integrals could be used to compute convolutions.

To compute the linear return distribution of a combination of leveraged investments, first the unleveraged linear-return distributions of the individual investments are leverage-transformed as above. Then leveraged linear-return distributions are convolved together into a single linear return distribution. Once the convolution of linear returns is computed, the convolved distribution could be translated up according to the net in-flow fraction of new money l added, as well as translated down by the cost of interest paid on margin debt, computed as max (0, −M+Σᵢ₌₁ⁿ|lᵢ|)(e^{r}−1), with exponential growth rate per time period r of the margin account debt, and maximum leverage M (normally 1) beyond which margin interest is charged. These simple translations are shown in the following expression.

$$( combined linear return distribution ) + I - max ( 0 , –M + {\sum }_{i = 1}^{n} \vert {l}_{i} \vert ) ( {e}^{r} - 1 ) \qquad ( 33 )$$

Also in the above, Σᵢ₌₁ⁿ|lᵢ| should basically be less than the margin account's allowed maximum leverage, though most margin accounts set different equity requirements for different assets held on margin. Such complexities are slightly outside the scope of this publication, and are expected to be adequately solvable by a programmer in this subject domain.

Convolutions computed as in Expression 32 above compute the distribution of combined returns assuming that the distributions being combined are independent. It is relatively easy to do some postprocessing of the convolution of multiple distributions in the case where the individual distributions are correlated with each other. Though it is true that the variance of a sum of independent random variables is the sum of the variances of the individual variables, this fact does not hold in the case where the variables being summed are correlated and are therefore not independent. In the event where a set of random variables are summed (or convolved, if dealing with the distribution of the sum) with scaling factors defined by the elements of the leverage vector l, the variance of the resulting sum is l^{T}Σl, where Σ is the covariance matrix of the unsealed variables. Thus, the variance of the convolution of a set of scaled correlated variables should be simply corrected to agree with the above fact, via multiplication of the factor \sqrt{l^{T}Σl/ν_{consolution}}, where ν_{convolution} is the variance of the convolution computed while assuming independence of the variables.

Put into practice with separate individual stocks, it may be that even the variance correction of the resulting convolution from Expression 32 is not enough to describe the convolution distribution to provide accurate optimal leverages; in fact, even higher order terms of interdependence could be at play in a highly correlated stock market where stocks all tend to move together. However, it doesn't seem very simple to directly perform these higher order corrections of 3rd and 4th moments, because while there are only

$$( \begin{matrix}d \\ 2\end{matrix} ) = \frac{d !}{( d - 2 ) ! 2 !} = d ( d - 1 ) / 2$$

variance and covariance coefficients (with d being the number of stocks), there are already

$$( \begin{matrix}d \\ 3\end{matrix} ) = \frac{d !}{( d - 3 ) ! 3 !} = d ( d - 1 ) ( d - 2 ) / 6$$

third moment coefficients contained within a symmetric 3 dimensional tensor matrix. Note that each of these centralized moment coefficients is computed as [symbol] (xᵢ−x̅ᵢ)(xⱼ−x̅ⱼ)(xₖ−x̅ₖ) [symbol] , where x̅ᵢ represents the mean of the i^{th} variable (out of d variables). To compute the expected 3rd moment of the convolution given the leverage vector of weights of each stock, the “cubic form” of the 3d tensor matrix is computed using this leverage vector: first the cubic matrix is multiplied by the leverage vector to yield a symmetric 2d matrix formed from that linear combination of (symmetric) 2d stacked matrices of the 3d cubic tensor matrix. Finally the expected 3rd moment of the convolution is reached as the quadratic form l^{T}Σl of this symmetric 2d matrix Σ with respect to the leverage vector l. Once the expected moments are known, given, e.g., the first 3 expected moments of the convolution, the points of the convolution distribution itself can be transformed using a polynomial with 3 coefficients, because it is possible to use the 3 moments to find 3 polynomial coefficients that will make the distribution match those moments, via the solution of a system of nonlinear equations.

Fortunately there is an easier way that avoids computing convolutions, tensor matrices, and solving systems of nonlinear equations, while producing a fairly accurate representation of the distribution of the combination of returns. This method directly computes the samples of the combined distribution by taking the dot product of the d-dimensional leverage vector with each time series sample vector of d linear returns (computed for example over daily time frames, as price(dayᵢ)/price(dayᵢ₋₁)−1) of the investments as they co-occur.

Perhaps, before taking the dot product of a leverage vector with multiple historical time series, the true financial analysis forecast-adjusted historical time series, as produced at the end of Section 3.2.2, could be transformed to the linear return domain and substituted for the raw unprocessed time series of linear returns. After the processed log-return time series are transformed to linear returns, the dot product of the leverage vector with the time series is taken to produce a combined time series of linear returns. This should be transformed to the log-return domain and then formed into a histogram using the process of entropy optimization with exponential time-fading as lined out in the prior section.

That log-return histogram should then be transformed, following the nonlinear transform procedure, to the histogram of linear returns. This linear return histogram could be translated according to Expression 33 to take account of margin interest expense and cash inflows or outflows.

This resultant combined linear return histogram should be transformed yet again to the log-return domain for the aforementioned process of entropy optimization with exponentially fading time weighting, and then nonlinearly transformed to a histogram of inverse multipliers of assets using the transform y=e^{-x}.

To compute the expected value of this distribution of inverse assets, the histogram is again morphed into one with equal-sized intervals for a more accurate computation of expected value. With the equal-interval histogram, the center of each interval is simply multiplied by the weight of the interval to compute the expected inverse asset multiplier of the combined portfolio of investments. This is ultimately the quantity to be minimized by an optimization program or algorithm, by tuning the leverage vector. The optimization program or algorithm may apply appropriate constraints on the leverages to express qualitative diversification goals or specific margin limits

### 3.3 Advantageous Effects of the Invention

Intuitively, minimization of expected inverse assets seems to minimize risk of bankruptcy. Furthermore, the elimination of other utility functions from consideration should allow more consensus and confidence to form in the world of financial economics. A greater common understanding of safe levels of leverage could increase the usefulness of markets in society.

As Chan pointed out [4], for an investment that was chosen for its good Sharpe ratio, leverage can be further optimized, because the Sharpe ratio is basically unaffected by the leverage.

The expected inverse asset objective function is significantly safer than the Kelly Criterion, since it invests only about half of what the Kelly Criterion would say to invest, in a couple of fairly realistic analytic scenarios. Widespread knowledge and usage of the expected inverse asset utility function would probably make markets less susceptible to dangerous financial bubbles.

It may be reasonable to expect greater returns from a retirement fund portfolio, as there are no longer any subjective risk tolerance parameters to consider. Leverages should theoretically depend only on the instantaneous (subject to liquidity constraints) forecast of returns, rather than requiring sufficient time for an “aggressive” investment to be considered “safe.”

### 4 DESCRIPTION OF EMBODIMENTS

### 4.1 Example: Leveraging in Market Equities

Leveraging in market equities can be accomplished by simply reviewing Sections 3.2.2 and 3.2.3.

### 4.2 Example: Leveraging with Debt

The root objective of minimizing the expected reciprocal assets seems to imply that the assets must be positive in order for the objective to be applicable. However, because the reason for minimizing the reciprocal assets is to avoid bankruptcy, the assets available for investment, which could include available debt (but excluding margin account debt), are the true quantity whose expected reciprocal should be minimized Recall from the Background Section 2 that the assets available for investment (including debt assets but excluding margin debt) were also used as the denominator component in this document's definition of leverage.

If the non-margin debt taken has a repayment schedule, the repayment requirements usually increase with time, degrading the growth rate in the future. Thus to maintain a low risk of bankruptcy in the future, a forecast is required of the earnings distribution, and preferably their dependence on leverage, through time. Given this general forecast, the goal should be to apply a debt payoff and investment strategy (controlling the leverage through time) that aims for a steady exponential growth rate in the assets (which are considered eligible for investment) while basically minimizing the maximum, over time, of the expected value of the inverse assets.

The optimal amount of debt to carry has also been determined, because both the debt payoff schedule and the possibility of taking additional debt are considered in the optimization process.

### 4.3 Example: Leveraging in Insurance

An insurance company would invest their assets just as any investor would, as far as balancing the leverages in their portfolio is concerned, with the very important exception that the fraction (or percentage divided by 100) of cash inflows I in Expression 33 would not simply be a steady stream of income from insurance premiums, but rather fluctuate due to the payment of insurance claims. Periods of high insurance claim activity might tend to occur at the same time as a drop in market equity prices, making it more difficult to rely on selling investments to pay out on an abnormally large number claims. Thus it would be important to make forecasts of the joint probabilities of different investment returns and insurance claims, and optimize the insurance leverage parameters simultaneously with the investment leverage parameters, and thus in effect accounting for insurance revenue and claims the same way that investments are forecast, rather than considering the claims payments as regular cash outflows I in Expression 33.

The joint probabilities can be taken into account using either corrections to convolution forecasts to take account of co-occurrences due to 2nd order and other higher order moments, or perhaps it would be sufficient to simply take account of co-occurrences without the use of convolutions and instead by conjoining historical datasets using the time of occurrence of all events impacting assets levels from various classes of insurance and investment. It may be that different types of events have different liquidity constraints, and therefore occur over different time frames. To account for this complication, a minimum time frame could be set, perhaps at one-half of a day, and the cost or credit of the event could simply be spread evenly over the appropriate number of half-days, depending on the liquidity constraints of the event. The elements of each time series would simply be the linear asset levels at each time step if all assets (perhaps normalized to be initially 1) were invested in the investment or insurance class of that time series. Next, some carefully constructed investment or insurance class-specific forecast could be applied to each class of investment or insurance time series by, for example, adjusting the mean logarithm (of one plus the fractional return) and perhaps standard deviation of the logarithm of the class-specific time series to match the forecast. Finally a leverage vector that assigns a multiplier to each of the linearly-accounted investment and insurance time series is optimized by constructing a combined time series using the leverage vector and then constructing a histogram (as described in Section 3.2.2) from the combined time series, from which the expected inverse assets are computed, in effect from each leverage vector. The optimization algorithm would then proceed to spend some amount of time attempting to find a leverage vector that makes the expected inverse assets as small as possible. The resulting optimized leverage vector is then interpreted as the optimal amount to invest in each investment class or equity, and the optimal number of units of each insurance class to insure.

### 4.4 Example: Leveraging in a Retirement Portfolio

Leveraging in a retirement portfolio should be covered by the same framework as leveraging in equities, e.g. following the framework set out in Sections 3.2.2 and 3.2.3. Particularly in a retirement portfolio, the net regular inflow I from Expression 33 would typically be negative, and basically as large as the retiree's regular cash requirement from the portfolio. As will be shown, because I is negative in a retirement portfolio, rather than positive, the total leverage will be smaller as compared to an equivalent portfolio with positive I, due to the entire histogram of returns being shifted down rather than up, thereby emphasizing the negative returns in the histogram.

The example at the end of Section 3.1.3 illustrates a biased aversion of the expected inverse asset utility function against downside returns. Intuitively (after using numeric simulations), it just seems that after shifting all the returns in a return distribution histogram down by a constant, the total leverage must be shrunken to maintain optimality. Intuition can be misleading though, so the mathematical proof of this can be seen by consideration of a few expressions.

If the expected inverse assets are computed using the sum Σᵢ₌₁ⁿ wᵢ/(1+lrᵢ), where leverage is l, and the rᵢ are the linear return fractions in a histogram weighted by wᵢ, the situation where the histogram is shifted down by a constant c is represented by the following expression for expected inverse assets: Σᵢ₌₁ⁿ wᵢ/(1+lrᵢ−c). If the leverage is optimized for the first unshifted scenario, then the derivative of that expression with respect to l is equal to zero: Σᵢ₌₁ⁿ−wᵢrᵢ/(1+lrᵢ)²=0. But notice that breaking it up into separate sums for positive and negative rᵢ, such that the sum of the derivative terms over the set Sₙ={i|rᵢ<0} of indices corresponding to negative rᵢ and the negated sum of the terms over the set of indices Sₚ={i|rᵢ≧0} corresponding to positive rᵢ equal each other: Σ_{i∈S}_{ₙ}−wᵢrᵢ/(1+lrᵢ)²=Σ_{i∈S}_{ₚ} wᵢrᵢ/(1+lrᵢ)².

Now, considering the scenario where each of the post-leveraged linear return fractions lrᵢ in the histogram are shifted down by a fixed amount c (with 0<c<1+lrᵢ, ∀i), the corresponding derivative terms equation becomes a strict inequality, by observing that

$${\sum }_{i ∈ {S}_{n}} \frac{{–w}_{i} {r}_{i}}{{( 1 + {lr}_{i} - c )}^{2}} = {\sum }_{i ∈ {S}_{n}} \frac{{–w}_{i} {r}_{i}}{{( 1 + {lr}_{i} )}^{2} {( 1 - \frac{c}{1 + {lr}_{i}} )}^{2}} > \frac{1}{{( 1 - c )}^{2}} {\sum }_{i ∈ {S}_{p}} \frac{{w}_{i} {r}_{i}}{{( 1 + {lr}_{i} )}^{2}} > {\sum }_{i ∈ {S}_{p}} \frac{{w}_{i} {r}_{i}}{{( 1 + {lr}_{i} )}^{2} {( 1 - \frac{c}{1 + {lr}_{i}} )}^{2}} = {\sum }_{i ∈ {S}_{p}} \frac{{w}_{i} {r}_{i}}{{( 1 + {lr}_{i} - c )}^{2}} . \qquad ( 34 )$$

This inequality shows that the derivative of the expected inverse assets with respect to l is positive after shifting the histogram down by c. Thus, by increasing the leverage, the utility function gets worse and so the leverage should, indeed, be decreased when the histogram is shifted down.

As mentioned at the end of the Advantageous Effects section (§3.3), it seems there are no longer any subjective risk tolerance parameters to take into account, and leveraging depends only on the instantaneous (subject to liquidity constraints) forecast of returns. Though leverage should be lower than it would be without the regular disbursements from the portfolio, it is still optimally guided by the expected inverse asset objective.

### 5 INDUSTRIAL APPLICABILITY

Despite its simplicity, minimization of the expected multiplicative inverse assets is a non-obvious leveraging strategy, distinguished by straightforward analysis, and potentially applicable by any financial entity as their root leveraging optimization criterion. It would be particularly applicable for managing risk for insurance, portfolio balancing, total leverage analysis, and perhaps even credit rating.

Expected inverse asset optimized leveraging is a process that could be applied individually to millions of retirement accounts, to quantitatively optimize a qualitative strategy. General wasteful uncertainty about risk levels, public and private, could be greatly reduced by increased consensus brought about by the mathematical soundness of the expected inverse assets objective.

### BRIEF DESCRIPTION OF THE DRAWING

Drawing 1: Illustrating the expected log-utility improvement while using the optimal leverage from Expression 27 for the expected inverse asset objective. This drawing therefore plots Expression 31. On the open domain of probabilities p∈ (0.5, 1), the value of the log-utility across the domain is greater than zero and steadily rises, showing notable improvement in the expected log-assets, as long as p is a winning probability greater than 0.5.

### REFERENCES

[1] D. Bernoulli, “Exposition of a new theory of the measurement of risk,” Econometrica, vol. 22, pp. 22-36, 1954, translated to English by Louise Sommer, originally published 1738.
[2] S. Russell and P. Norvig, Artificial Intelligence: A Modern Approach, 2nd ed. Prentice Hall, 2002, ch. 16.3.
[3] J. Kelly, Jr., “A new interpretation of information rate,” Bell System Technical Journal, vol. 35, pp. 917-926, 1956.
[4] E. Chan, Quantitative Trading: How to Build Your Own Algorithmic Trading Business. Wiley, 2008.
[5] E. O. Thorp, The Kelly Criterion in Blackjack Sports Betting, and the Stock Market, 1st ed. North Holland, 2006, ch. 9, pp. 386 428.
[6] W. Poundstone, Fortune's Formula. Hill and Wang, 2005.
[7] J. Scott, C. Jones, J. Shearer, and J. Watson, “Enhancing utility and diversifying model risk in a portfolio optimization framework,” U.S. Pat. No. 6,292,787, Sep. 18, 2001.
[8] O. Peters, “Optimal leveraging from non-ergodicity,” Quantitative Finance, vol. 11, pp. 1593-1602, 2011.
[9] R. Mulvaney and D. S. Phatak, “Regularization and diversification against overfitting and over-specialization,” University of Maryland, Baltimore County, Computer Science and Electrical Engineering TR-CS-09-03, Apr. 3 2009.
[10] J. C. Hull, Options, Futures, and Other Derivatives (5th Ed.). Prentice Hall, 2003.

1. An improved financial portfolio leverage planning process is claimed
wherein the process takes account of information to produce a leverage plan;
wherein a financial portfolio is defined as a list of investments along with a vector of leverages, called a leverage vector, to specify the amount of each investment;
wherein an investment is defined here as money placed under risk with the hopes of a positive return on the amount invested, and investments are distinguished from one another by one or more cohesive factors;
wherein the claimed process above is comprised of the following elements:
any method, such as one exemplified in Section 3.2.2, to produce a forecast of the instantaneous return distribution of an investment;
any process of computation of a single portfolio-wide instantaneous forecast return distribution, such as one exemplified in Section 3.2.3, carried out by a computation device, from forecasts of all the investment components of a leverage-vector-weighted portfolio, and possibly including any regular interest payments and inflow or outflow of cash;
and any numerical variable optimization algorithm, such as one applicable by a person of average skill in the field of numerical optimization, to determine, within a given, possibly iterated time limit, an optimized portfolio leverage vector to invest by minimizing the expected inverse assets of the portfolio, given the portfolio-wide instantaneous forecast return distribution for any leverage vector and net inflow of cash after interest;
wherein the claimed improvement is:
minimization by the optimization algorithm of the newly derived expected-inverse-asset objective function, to achieve reduced risk in the form of having a low probability of having nearly zero assets available to invest, via optimized modification of the leverage vector of the portfolio.
